(19) United States
(12) Patent Application Publication
(10) Pub. No.: US 2015/0305482 A1
(43) Pub. Date: Oct. 29, 2015

(54) TOOTHBRUSH WITH FULL-GRIPPING HANDLE

(71) Applicant: ANDY THANG TRAN, San Jose, CA (US)

(72) Inventor: ANDY THANG TRAN, San Jose, CA (US)

(21) Appl. No.: 14/694,964

(22) Filed: Apr. 23, 2015

Related U.S. Application Data
(63) Continuation-in-part of application No. 13/889,807, filed on May 8, 2013, now abandoned.
Application No. 13/889,807 is a continuation-in-part of application No. 13/910,090, filed on Jun. 4, 2013, now abandoned.
Application No. 13/910,090 is a continuation-in-part of application No. 14/177,017, filed on Feb. 10, 2014.

(51) Int. Cl. A46B 5/00; A61C 17/22; A61C 17/34; A46B 5/02

(52) U.S. Cl. CPC A46B 5/0095; A46B 5/02; A46B 5/026; A61C 17/225; A61C 17/3481

(57) ABSTRACT

A manual or electrical toothbrush for cleaning teeth and gum pockets, the toothbrush including a neck portion; a brush head connect to one end of a neck portion; and a handle coupled to the neck portion and completely encased with gripping elements for full-gripping.

This application is a continuation-in-part application of application Ser. No. 14/177,017, filed 2 Oct. 2014, Ser. No. 13/889,807, filed 8 May 2013, and Ser. No. 13/910,090 filed 4 Jun. 2013, the contents of which are incorporated by reference.

### BACKGROUND

The present application relates to manual toothbrushes and mechanical/electric toothbrushes whose handles are entirely encased in an array of gripping elements. The handles can also be entirely encased in flat-surface but tacky materials. The full-gripping handles are round, oval, conical, octagon or polygon-shaped and operate by user's thumb, forefinger and middle finger similar to a pencil grip.

Cleaning teeth and gum pockets with a toothbrush is a very important practice of today's daily personal oral hygiene care. An ergonomic toothbrush handle with tacky grip covering the entire handle couples with the user's gentle and accurate pencil grip tooth brushing technique similar to the grip that of dentists and dental hygienists are using will help promoting the bristles to get between teeth and into gingival pockets, prevent damage to the gum (gum recession), minimizing tooth abrasion and effectively and easily removing food debris and dental plaque on teeth and under gingival pockets. Dental plaque is a colorless or pale yellow layer of bacteria that colonizes the surface of all teeth and in gingival pockets. If dental plaque and food debris are left on teeth surfaces or under gum pockets for a period of time, they can irritate the gum and lead to bad breath, gum disease, other serious health problems as well as tooth decay. Dental plaque that is not removed in time will also harden into dental tartar—a combination of hardened plaque and mineral from saliva forming rough surfaces—which can harbor more dental plaque and increase a person's chance of getting gum inflammation (gingivitis) and later periodontal disease (periodontitis). Periodontitis is known for promoting inflammation of the blood vessels, an important risk factor for atherosclerosis. Atherosclerosis is a chronic, progressive disease in which plaques (consisting of deposits of cholesterol and other lipids, calcium, and large inflammatory cells called macrophages) build up in the walls of the arteries and cause cardiovascular disease. Periodontitis causes destruction of bone and gum around a tooth and can lead to premature tooth loss. In addition, if food particles and dental plaque are left on teeth surfaces and in gum pockets for too long, bacteria in the mouth will turn them to acids which will eat away your tooth structure and over times can lead to tooth decay. If tooth decay is left untreated, it will lead to tooth pain due tooth sensitivity, tooth infection, and in worst case scenario tooth root canal and tooth loss. Brushing teeth and gum pockets properly using a toothbrush also help with halitosis (bad breath) and having a naturally white set of teeth without the need for teeth whitening procedures which can cause teeth sensitivity and gum irritation. Thus, it is necessary to have an ergonomic toothbrush handle in order to help the users remove as much as possible food and dental plaque, to prevent gingivitis, periodontitis, bad breath and to have a white set of teeth.

The prior art is replete with various renditions of toothbrush designs. The vast majority are mainly concerned with the technical aspects of improving the brushing efficiency of the toothbrush as a whole. There are some with larger handles that are intended to house an electric motor or store some other tooth brushing aid. Some handles are made large enough to store the head of a traveling toothbrush. A few of the above designs make some efforts to ease the user's control of the toothbrush bristles but all are held in the users' palms and using mostly wrists to change the direction of the toothbrush and navigate around each tooth or angle bristles against teeth surfaces by bending the users wrists lifting users arms, and other convoluted moves that make it extremely difficult if not impossible for the users to access all teeth surfaces and gum pockets of all teeth. As a result, many users are unable to effectively reaching gum pockets, line angles of teeth, interproximal of teeth, lingual surfaces of anterior teeth and distal surfaces of the molar teeth in the mouth. Other users try extremely hard to brush the above areas and inadvertently cause gum damage (gum recession) and tooth abrasion (grooves at the neck of the teeth) due to the powerful force and action from the arm muscles as well as poor control, poor accuracy of the user's fist/palm. Beebe, U.S. Pat. No. 4,283,808, teaches an after-market gripping device for tooth brushes adapted to be positioned over the handle of the toothbrush wherein the device is formed of soft plastic foam material. The problem with the plastic foam gripping device is that plastic foam tends to absorb moisture, therefore, by its very nature, is unsanitary. Furthermore, the consistency of plastic foam enables the toothbrush handle to move independently from the exterior surface of the slip on gripping device. The independent movement of the toothbrush, caused by the inherent mechanical instability of foam plastic, creates a condition wherein the all-important rotational and longitudinal control of the toothbrush handle is virtually nonexistent.

U.S. Pat. No. 5,305,490 discloses a light weight monolithically fabricated toothbrush affording a person with inadequate hand strength greatly improved gripping and control characteristics by utilizing an enlarged lightweight tubular handle with an anti-slip gripping surface specifically designed to deter retention of bacteria forming moisture and excess toothpaste. In a parallel note, U.S. Pat. No. 6,081,928 discloses a thin elastomeric glove with enhanced gripping surfaces molded into the gripping surfaces of the glove is described.

Many conventional toothbrushes often slip in the hand due to leakage of toothpaste and saliva from the mouth and such slippage can cause injury to the user. For example, one user jammed the plastic edge of her toothbrush hard against her lower right-hand outside gum. No bleeding occurred, but in the days since, some sort of white blister has developed and is sensitive to the touch. It looks like a short (inch-long) line along her gum where the toothbrush hit. Another user reported that his toothbrush slipped in his mouth while brushing and cut up his upper gums. Such slippage can cause severe pain in certain cases, and may lead to inadequate brushing of the teeth. Thus, what is needed is a toothbrush that is easy to handle and that provides a comfortable and secure grip even when the users apply a minimal force on their grasps.

### SUMMARY

In one aspect, a manual or electrical toothbrush with a round, octagon, conical, oval, polygon handle which are fully covered with gripping elements or flat but tacky materials and a method for brushing teeth and gum are disclosed.

In another aspect, a manual or electrical toothbrush for cleaning teeth and gum pockets: the toothbrush including a neck portion; a brush head connect to one end of a neck portion; and a handle coupled to the neck portion and completely encased with gripping elements for full-gripping.

In yet another manual or electrical toothbrush with full-gripping handle and a method for brushing teeth are disclose, including picking up a toothbrush below the neck portion, a toothbrush head extending from one end of the neck portion, a round, octagon, oval, conical, polygon-shaped handle extending from the other end of the neck portion, wherein the grip handle includes an array of gripping elements fully cover the entire surface of the toothbrush handle; and brushing a user's teeth and gum pockets. Lights can be provided on the toothbrush neck and upper part of the handle to help the toothbrush users maintain the toothbrush bristles in straight shape or form as well as viewing teeth, gum and tongue.

Implementations of the brush may include one or more of the following. The toothbrush can be used by holding the toothbrush as though the toothbrush is a pen, a pencil or a chop-stick or similar to the way the dentists and dental hygienists hold their dental instruments. During the two-minutes teeth cleaning procedure the toothbrush user always maintains the elbow of the toothbrush holding fingers in down position next or close to his side; He always maintains the wrist of the toothbrush holding fingers straight and letting only the fingertips and sometimes the forearm of the toothbrush holding fingers to control the direction of the toothbrush for gentle brushing; The toothbrush users can roll the grip handle in his fingertips to adjust angles of the toothbrush bristles against the teeth to form the 45 degree angles when brushing teeth. The full-gripping handle can be cylindrical-shaped, oval-shaped, coned-shaped, octagon-shaped or polygon-shaped. The method includes comprising providing bumps or studs covering the entire surface of the grip handle. The method includes comprising providing concave indentations covering the entire surface of the grip handle. The method includes comprising providing suction cups covering the entire surface of the grip handle. The method includes comprising forming continuous line extrusions or continuous concave depressions covering the entire surface of the grip handle. The method includes comprising providing flat, yet tacky gripping surface covering the entire surface of the handle. The method includes comprising holding the grip handle with a chopstick finger grip or a pencil finger grip. For motorized/powered/electrical toothbrushes, the method includes full-gripping handle which can be cylindrical-shaped, oval-shaped, coned-shaped, octagon-shaped or polygon-shaped. The method includes comprising providing bumps or studs covering the entire surface of the grip handle. The method includes comprising providing concave indentations covering the entire surface of the grip handle. The method includes comprising providing suction cups covering the entire surface of the grip handle. The method includes comprising forming continuous line extrusions or continuous concave depressions covering the entire surface of the grip handle. The method includes comprising providing flat, yet tacky gripping surface covering the entire surface of the handle. The method includes comprising holding the electrical/powered/motorized full-gripping toothbrush handle with a chopstick finger grip or a pencil finger grip plus a vibrator in the grip handle. Brush bristles on the toothbrush head can have varying height to allow the head to brush a hard-to-reach dental region. The vibrator comprises a motor that is improperly balanced for vibration.

Advantages of the preferred embodiments may include one or more of the following: The toothbrush includes a cylindrical, oval, conical, octagon or polygon-shaped handle with gripping portions such as bumps or recesses around the entire cylindrical, oval, octagon, conical, polygon handle that help the user with keeping a grip on their toothbrush or rolling the toothbrush handle in their fingertips to adjust the bristle angle with tooth surfaces as they brush. The gripping elements completely encase the toothbrush handle in such a way that wherever the user wants to hold or touch, there is gripping element present. This allows for many different griping positions and ensures that the grip is not lost during tooth brushing. The use of this toothbrush also allows the user to hold the brush at a 45 degree angle with their fingertips, control the direction of the toothbrush handle and still able to keep his wrist perfectly straight. The handle can be held similar to a pencil or chopstick due to the cylindrical, oval, octagon, conical, polygon-shaped handle does not have pre-cut grooves for the hand, allowing for unique grips on the brush.

The preferred embodiments prevent the problem of the typical toothbrushes including battery powered ones which have pre-cut grooves on the handles which lead most if not all users to hold the toothbrushes firmly as though they hold file handles or hammer handles in their fists. This kind of firm grip is not recommended by toothbrush makers or dental professionals but the average toothbrush users never know that they are not supposed to hold their toothbrushes in such ways. In addition, all toothbrush makers don't have instructions showing toothbrush users how to hold the toothbrushes by printing such information on packages or user's manuals. As a result, most users just hold the toothbrushes the same way of which they hold the toothbrushes as they did at one or two years old which is a firm grip on the toothbrush handles and brushing with heavy force from the arm which will lead to splaying of bristle tips and excessive friction and pressure on teeth and gum as the bristles making contact with them, as a result, gum recession and tooth abrasion are today's common dental problems. To effectively brush teeth and gum, gentle pressure must always be applied to allow the bristle tips staying straight, accurate and making direct contact with plaque and food particles on teeth surfaces and inside gum pockets which have very tiny access areas. If excessive pressure and fast brushing actions are applied, the bristle tips will be bent and point away of the intended areas. The system provides an affordably priced practical one piece or replaceable brush head of manual or electrical toothbrush having a tacky or full-gripping, tubular/oval/octagon/conical/polygon handle specifically designed to afford a left or right handed person to comfortably, accurately and controllably grasp the toothbrush handle to give them the precision and gentle pressure that protect the their teeth and gum from toothbrush abrasion and gum recession. The full-gripping toothbrush handle provides an anti-slip sanitary appliance toothbrush handle fabricated of impermeable material to prevent moisture absorption. The toothbrush handle is also designed in such a manner to discourage the palm grasp as well as the retention of moisture and excess toothpaste and the resultant potentially harmful bacteria. The toothbrush handle can be held as though it is a pencil or a chopstick or dental instruments and thus provides fine-grain brushing motion to clean hard to reach surfaces. Additionally, the toothbrush is compatible with left or right hand users. The claimed studded outside though out the toothbrush handle can also be applied to electrical toothbrush handles since the automatic toothbrush has a tendency to slowly slip out of the user's hand. They can use the fully studded handle to keep the toothbrush from slipping of the fingers and still receive feed-back from the bristles as they make contact with teeth and gum sulcus. This also allows the toothbrush handle to act as a massager for the user's fingers. The bumps on the toothbrush handle of the toothbrush can be placed at even intervals and spread from the start of the toothbrush handle at the neck of the toothbrush to the end or near the end of the toothbrush handle.

Further advantages of this invention will be outlined in the accompanying drawings and specifications.

### BRIEF DESCRIPTION OF THE DRAWINGS

FIGS. 1A, 1B and 1C show a back view, a side view, and a front view of an exemplary tooth brush in accordance with the present invention.

FIG. 2 shows an exemplary toothbrush embodiment with protruding lines or recessed lines and/or dots covering almost the entire surface of the grip handle.

FIG. 3 shows an exemplary grip with on embodiment of the toothbrush.

FIG. 4 shows control circuitry of an exemplary motorized vibrating toothbrush.

FIG. 5 shows another embodiment for a lighted toothbrush.

FIG. 6 shows embodiments to help clean specific dental locations.

### DESCRIPTION

A manual or electrical toothbrush is disclosed that includes toothbrush handle that has round/tubular/oval/octagon/conical/polygon-shaped handle with flat yet tacky or non-slip gripping elements covering the entire surface of the toothbrush handle which enables the user to hold it the way he holds the pen/pencil or chop-stick or dental cleaning instruments. As he brushes his teeth holding the toothbrush in his fingertips, the elbow on his toothbrush holding side will be in relax/down position next to his side (if he holds the toothbrush in his fist/palm, he has to keep the elbow at shoulder level or bends the wrist as he brushes his opposite side with his toothbrush holding hand). In addition, with the toothbrush in his fingertips, the wrist can always stay straight and not bend or turn like in the fist/palm gripping tooth brushing and this allows the fingers to move freely as they control the toothbrush handle. Because the fingertips and sometimes forearm do all the works, while holding the toothbrush as holding a pencil/dental cleaning instruments, he can easily rolls the toothbrush handle in her/his fingertips to adjust angles of the toothbrush bristles against his teeth to form the 45 degree angles as recommended by dental professionals when brushing teeth. The non-slip grip that surround the entire toothbrush handle will help the user keep the toothbrush handle from slipping about as he moves the toothbrush in back and forth, vibrating or circular motions.

Brushing when holding the toothbrush the way the user holds a pencil/dental cleaning instruments will give him more control (precision) with the brush head to get to where he wants his toothbrush to brush. He can make circular motion much easier and smaller versus the traditional fist grip (e.g., writing/tracing a letter with pencil in fingertips versus pencils in the fist/palm).

Brushing when holding the toothbrush the way he holds the pencil/teeth cleaning instruments during the entire tooth brushing procedure will dramatically decrease the pressure on gum and teeth which will help decrease or even eliminate tooth abrasion, gum recession and teeth sensitivity which cause by heavy force from the arm thrusting action which commonly happened on people holding the toothbrush in the fist/palm. (Normal writing with fingertips always generates less pressure against the paper surface than writing holding pen in one's fist/palm).

Advantageously, brushing when holding the toothbrush handle as holding a pencil will not cause the tips of the toothbrush bristles to get crushed or bent as easily as holding the toothbrush handle in the fist. Since the bristle tips are the one that clean, keeping the bristle tips standing up straight, they are much more effective in removing plaque and food debris. Most of people who hold the toothbrushes in their fists will damages the toothbrush bristles in a few times of brushing. Once the bristles are splayed (even slightly) the toothbrush becomes less or poorly effective in removing plaque and food debris. As a result, many users mistakenly think that they have not brushed well enough and try brushing harder in order to get to the plaque and food. Such harsh, aggressive brushing will causes gum loss and tooth abrasion.

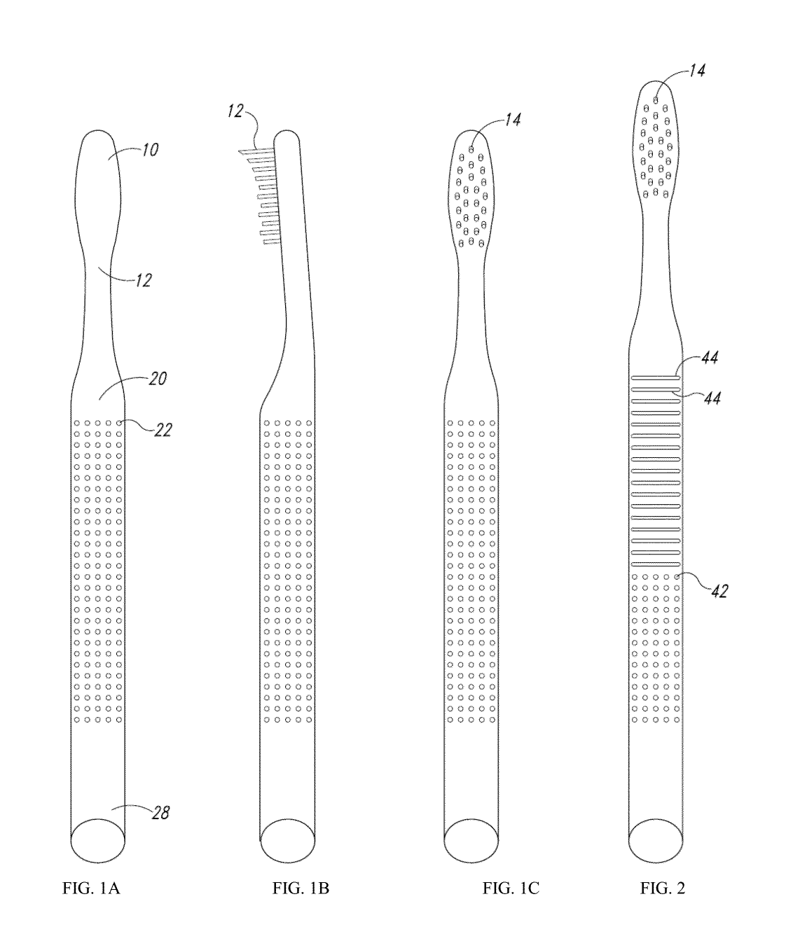

FIGS. 1A, 1B and 1C show a back view, a side view, and a front view of an exemplary toothbrush in accordance with the present invention. The toothbrush has a narrow neck 12 that widens on a toothbrush head 10 to support toothbrush bristles 12-14. The narrow neck 12 also widens into a cylindrical gripping portion (grip handle) 20.

In one embodiment, the narrow neck is directed downward with a slant. This structure enables the user to easily brush his or her teeth in a relaxed posture without widely opening his or her mouth.

The grip handle 20 includes gripping elements such as bumps or recesses around and throughout the length of the cylindrical toothbrush handle that help the user with keeping a steady grip on their toothbrushes. The gripping elements completely encase the toothbrush handle leaving no part uncovered. This allows for many different grips and ensures that the grip is not lost during tooth brushing procedure. The use of this toothbrush handle also allows the toothbrush's user to angle the brush bristles at a 45 degree angle against the teeth, keeping their wrist perfectly straight. The handle can be held similar to a chopstick/pencil/dental cleaning instruments due to the cylindrical/oval/octagon/conical/polygon-shaped handle not having pre-cut grooves for the hand, allowing for unique grips on the brush.

The cylindrical gripped handle 20 includes an end portion 28 which can be curved in one embodiment, or can be flat and has no curve, similar to the bottom of a can. The bristles 12-14 on the brush are spaced evenly on the brush to help with even brushing. Preferably, the length of the brushes at the end of the brush increases to help reach different areas of the mouth. During manufacturing, the bristles 12-14 are bundled up and secured to the brush using small staples which fit into brackets on the mold of the brush.

In one embodiment, the gripping handle 20 includes a plurality of bumps or studs 22 cover almost the entire surface of the gripping handle 20. The bump, stud, or concave indentations provides the gripping portion 20 with increased surface area in the form of areas of bumps or suction on each of the gripping surfaces of the toothbrush. In one embodiment, the toothbrush has an outer surface for coming into contact with a finger. The bumps, studs, or concave indentations may be a single size and depth or various sizes and depths and are molded into the glove wherever additional grip is needed.

Alternatively, instead of bumps or studs, the gripping handle 20 can have concave indentations thereon. The concave or convex indentations are molded onto the brush to help with gripping the brush.

In yet another embodiment of the invention, the gripping handle 20 has an outer surface with an array of suction cups for coming into contact with finger(s). The suction cups define a plurality of suction portions on the outer surface of the glove. The suction cups may be a single size and depth or various sizes and depths and are molded into the surface of the glove wherever additional grip is desired.

The toothbrush of the invention has superior griping effectiveness as compared to typical toothbrushes. The increased gripping effectiveness of the gripping handle also allows the entire handle surface to be used “on demand” which means a gripping surface present wherever the user's finger touch the toothbrush handle.

This toothbrush handle is also superior to conventional toothbrush handle because it provides increased grip strength/effectiveness without affecting the tactile feel of tooth brushing. The toothbrush can be manufactured using conventional processing lines, injection molding, or other thin-walled plastic forming technologies (e.g., thermoforming, blow molding). To manufacture the toothbrush with a gripping surface comprised of a plurality of concave indentations, the toothbrush formers are provided with a surface comprised of a plurality of convex protrusions in those areas where improved grip strength is desired.

The material used in the toothbrush is a celluloid material and the bristles of the toothbrush are made from nylon. The way a toothbrush is made is through a mold in which plastic pellets are squeezed through pressure. The mold has holes for the brush bristles to be inserted into. The bristles are clumped together and stapled into the mold of the brush. Finishing touches are then added into the mold.

FIG. 2 shows yet another embodiment with protruding lines or recessed lines and/or dots covering almost the entire grip handle. In this embodiment, a series of lines 44 cover the almost the entire grip handle in combination with the bumps or concave indentations, or a combination thereof. Thus, alternating ridges followed by depressions can be formed on the surface of the grip handle. Another embodiment can alternatingly mix the protruding lines with a row of concave indentations. Other embodiments can have only protruding lines or recessed lines covering the entire grip handle. In these embodiments, the array of gripping elements includes continuous line extrusions as the case for one implementation. In another implementation, continuous concave depressions can be provided on the surface of the grip handle.

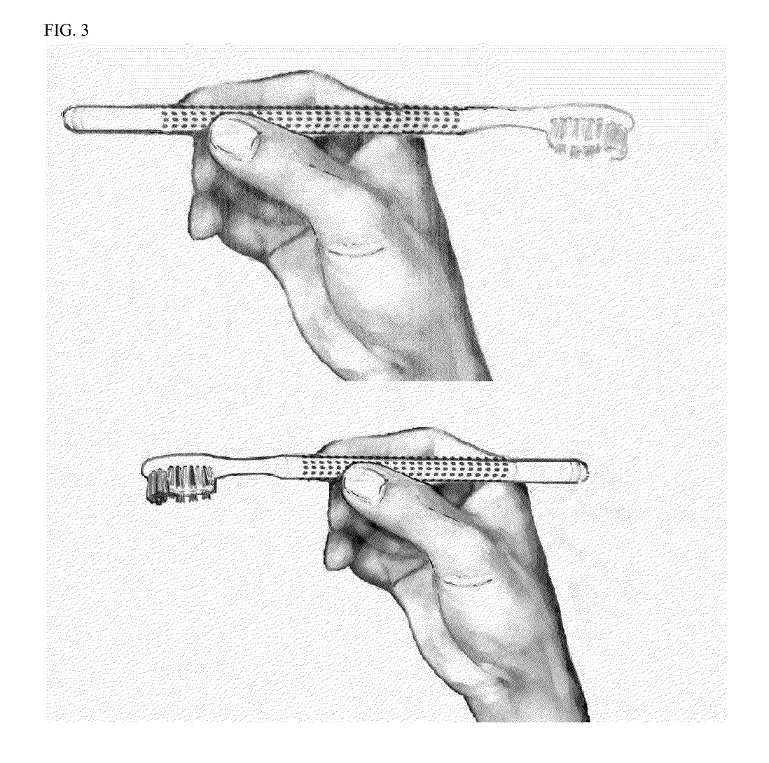

The full-gripping cylindrical/octagon/oval/conical/polygon-shaped handle of the toothbrush allows a variety of grips on the brush including a pencil, dental cleaning instrument or chopstick-like grip, as shown in FIG. 3. The user is holding the toothbrush handle like a pencil. In one embodiment, the user can put his or her fingers on the handle 20 while holding them about two-thirds of the way from the bottom of the handle 20 to brush the teeth on the toothbrush holding side. In one usage scenario, the user can hold the toothbrush in a basic tripod grip. The basic tripod grip is the same as the one the user uses for writing. The thumb and forefinger form a triangle with the middle finger as shown, which is supported by the ring finger and pinkie. This grip allows the toothbrush to be finely controlled by the fingers, so holding a toothbrush this way is ideal for brushing teeth with precision in the same way that a pencil can be used for drawing fine detail. The upright position of the toothbrush allows for accurate brushing with the brush tip, rather than the side of the brush. This gripping style is greatly aided by the secure grip afforded by the array of gripping elements of the preferred embodiment.

The round, pentagon, oval, conical, polygon-shaped, full-gripping toothbrush handle is used by the user's fingertips to brush teeth and gum pockets. Gentle action from the fingers is used to help the toothbrush users avoid toothbrush abrasion, gum abrasion and recession, and teeth sensitivity due to strong thrusting, poking, and scrubbing back and forth as toothbrush user holds the toothbrush in their fist/palm and brushes his teeth with his whole arm and bent wrist. The holding methodology also helps keep the user wrist staying perfectly straight during the entire 2 minute brushing. The toothbrush, along with the user's fingertips' rolling action, supports a 45 degree angle contact of the brush bristles with his teeth and engages the gum sulcus with accuracy and ease.

The bristle tips can stay straight, remain in constant contact with the teeth surfaces, slip between teeth and access gum sulcus with minimal effort. The toothbrush of FIGS. 1 and 2 can access any surfaces of a person's teeth without the need of raising arm or bending wrist.

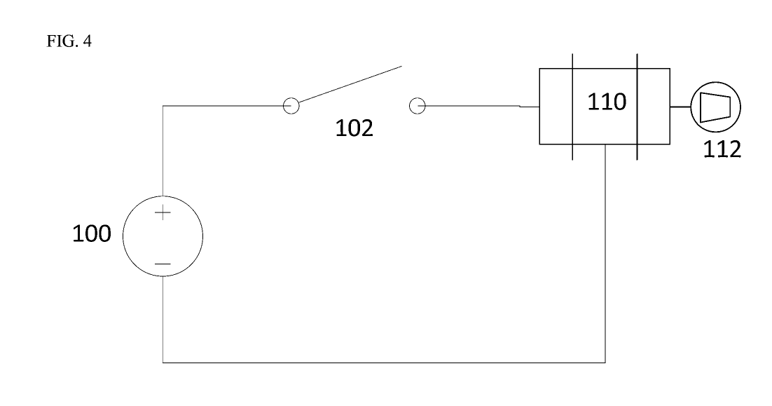

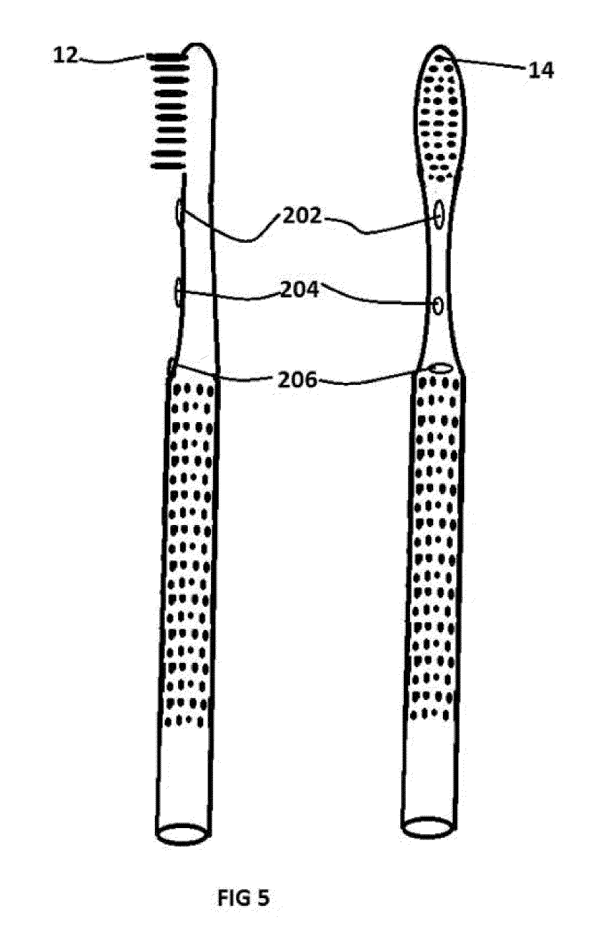

FIG. 4 shows an example of a secure grip electric toothbrush that has a design similar to the brush shown in FIG. 1 or 2. Since electric toothbrushes are more likely to slip than a regular toothbrush due to vibrations, adding friction to counteract the vibrations can greatly reduce the effects of the vibrating. The vibrating of the brush is intended to aid in removing plaque from the teeth. Although this can be helpful at times, it hinders the ability to have a secure grip on the brush handle. The motor of the brush is made to imitate the motion of using hands to hold the brush.

In FIG. 4, a battery 100 is connected by a switch 102 to provide power to a motor 110 with an unbalanced head 112 to form a vibrating motor, which is essentially a motor that is improperly balanced. In other words, there is an off-centered weight attached to the motor's rotational shaft that causes the motor to wobble. The amount of wobble can be changed by the amount of weight attached to the motor. The vibrating motor can be done by attaching any off centered weight to any motor shaft. They can also be created by breaking in half balanced components already attached to motor shafts. When the brush is turned on, the motor is activated and starts to move, imitating hand motions that help to increase food debris and plaque removal.

The powered toothbrush includes a cylindrical, conical, oval, octagon or polygon-shaped handle with gripping portions such as flat yet tacky materials, bumps or recesses around the entire said handle to help the user with keeping a grip on their toothbrush with minimal grasping force. The gripping elements completely encase the toothbrush handle in such a way of which gripping materials present wherever the user's finger tips touching them. This handle allows for many different grips and ensures that the grip is not lost. The use of this toothbrush handle also allows for the users to hold the brush bristles at a 45 degree angle against the teeth surface and keeping their wrist perfectly straight at the same time he is brushing his teeth. The toothbrush handle can be held similar to a chopstick or dental cleaning instruments due to the cylindrical/octagon/oval/conical/polygon handle not having pre-cut grooves for the hand, allowing for unique grips on the brush.

The preferred embodiments prevent the problem of the toothbrush from slipping out of the user's hand due to manufactures' recommendation of holding the toothbrush lightly with palm facing downward. To effectively brush teeth, stability must be maintained to make effective contact with the teeth to remove plaque and food debris. If the toothbrush constantly falls out of position or being held too tightly, then the brushing will be less effective, teeth will not be properly cleaned as expected and damages to tooth enamel and gum can happen. The system provides an affordably priced practical one piece or replaceable brush head electrical toothbrush having a secured griping covering the entire tubular/octagon/oval/conical/polygon handle specifically designed to afford a left or right handed person to comfortably, precisely and controllably grasps the toothbrush handle. The toothbrush provides an anti-slip sanitary appliance handle fabricated of impermeable material to prevent moisture absorption and designed in such a manner to discourage the retention of moisture and excess toothpaste and the resultant potentially harmful bacteria. The said handle can be held as though it is a pencil or a chopstick or dental cleaning instruments and thus provides fine-grain brushing motion to clean hard to reach surfaces. Additionally, the toothbrush is compatible with left or right hand users. The claimed studded outside can also be applied to automatic toothbrushes. Since the automatic toothbrush has a tendency to slowly slip out of the user's hand, they can use the studded handle to keep a solid grip on the toothbrush. This also allows the handle to act as a massager for the user's fingers. The bumps on the handle of the brush are placed at even intervals and spread from the base of the toothbrush neck to near the end of the toothbrush handle.

In one exemplary method of use, to brush the outside (facial) of the lower arch's teeth, the user picks up and holds the toothbrush handle below the toothbrush neck or anywhere around the upper ⅓ portion of the handle between his thumb, forefinger and middle finger with the toothbrush handle resting on the bottom of the U-shape part located between the thumb and forefinger. In other word, the toothbrush handle is held as holding a pencil to write. With the bristles facing his teeth, he then rolls the handle between his fingertips to position the bristles slightly downward to form a roughly 45 degree angle against the lower teeth surfaces. This also allows the bristle tips to engage and get into gum pockets as he brushes with ease. As he brushes the teeth on the opposite side of his toothbrush holding side (right handed person will brush his left side of his mouth and other way around for left handed user) either in circular motions of short vibrating motions for each tooth and working toward the front of his mouth. He then flips the toothbrush head toward the toothbrush holding side holding the handle at the middle ⅓ or mid-portion of the toothbrush handle and continues brushing the teeth on that side starting from where he stops earlier to brush the remaining side of his lower teeth. To brush the outside (facial) of the upper arch, the user repeats the same brushing way he did with the lower teeth but now rolling the toothbrush bristles slightly up to forms a roughly 45 degree angles against the upper teeth surfaces and gum pockets. To brush the inside/lingual surfaces of upper teeth, the toothbrush is held in the user's pencil grip or dental cleaning instrument grip with the butt of the handle pointing downward (upright) and bristles facing away from the user face. With his elbow close to the body, the user leans the brush handle backward slightly and horizontally toward the back of his mouth to reach the lingual of his upper back teeth. The user can roll the toothbrush in his or her fingertip to form a 45 degree angle against the tooth which he wants to brush. The teeth cleaning process repeats with the next tooth in front of the tooth which he has just brushed. The toothbrush handle should be held upright/vertical and the holding fingers spread out on the entire longitudinal length of the handle for stability control as he is working toward the back of the upper front teeth (ideal for tooth #4 through #13). The same type of brushing procedures repeats as the user works on the remaining side of the same arch.

To brush the lingual surface of the lower teeth, the user holds the tooth brush with his pencil grip with the thumb, forefinger and middle finger holding the mid-section or the bottom ⅓ section of the toothbrush handle, the handle butt pointing downward, the brush head pointing upward and bristles facing the user's face. He then uses his fingers to tips the brush head backward and toward his lower front teeth until the toothbrush becomes parallel with the ground as he maintains his elbow close to his side. He then brings the brush head toward the last tooth of either side of his mouth, rolls the toothbrush in his finger tips to form a 45 degree angle against the side of the tooth of which he intends to brush and begins brushing. He can shift the toothbrush handle to the corner of his mouth so the toothbrush bristles can make full contact and clean the mesial lingual surfaces of his teeth. He then brushes toward the front of his lower teeth (lingual of anterior teeth), his toothbrush handle will be in vertical direction with the handle butt points upward (ideal for tooth #20 to #29). The same way of brushing is repeated for the remaining side of the user's lower lingual teeth. Both techniques are recommended by dental professionals but holding the toothbrush handle in the fist/palm method makes it extremely difficult or almost impossible to effectively making proper contact with the inside of al teeth.

FIG. 5 shows another embodiment for a lighted toothbrush. In this embodiment, one or more lights 202-206 are positioned on the neck and/or the top of the handle. To conserve battery, an LED light can be positioned around the top part of the toothbrush handle and/or along the neck of the toothbrush with the purpose of illuminating the toothbrush bristles since keeping the bristles straight up during tooth brushing is important due to the fact that bristle tips is the ones that do the cleaning. Light also gives the user a better vision of the area where he/she is brushing. Since the LED has the advantages of a long lifetime, a small size, a high resistance to impact, a low heat emission, and a low consumption of electric power, the LED can be used to light the teeth for improved visibility. Additionally, the LED has been developed toward producing colorful lights and high brightness in recent years, so that the LED is further applied as a back light source of a small-sized display to become a stream of illumination light sources with low power consumption and low contamination. In a white light embodiment, alternatives to LED include electric bulbs or fluorescent lamps, even though white light LEDs stand on a vantage point that they have small sizes, high response speeds, low heat emissions, low consumptions of electric power, long lifetimes, high resistance to shock, and low contamination, and are able to be flat packaged.

It can also be other types of light that can illuminate the dental plaque. Dental plaque, colonies of harmful bacteria which form on tooth surfaces and restorations, cannot be flushed away by simply rinsing with water. Active brushing of the teeth is required to remove the plaque which adheres to tooth surfaces. The light can be ultraviolet light that is applied to the teeth to reveal the plaque.

Dental plaque, when allowed to accumulate on tooth surfaces, can eventually lead to gingivitis, periodontal disease, caries and calculus. Thus, it is apparent that effective removal of deposits of dental plaque is absolutely essential for oral health. Accordingly, proper oral hygiene practices which may be carried out by an individual on his or her own teeth or by a dentist would be facilitated by readily available means of identification and location of plaque deposits in the oral cavity.

Since dental plaque is usually transparent and colorless and not easily visible, an individual frequently is not aware of the quantity or the location of dental plaque present in the mouth. Plaque-disclosing compositions can be used with the light to identify areas of the mouth where plaque buildup is a problem. A number of dye indicators for dental plaque as a means of measuring tooth cleanliness and to affect proper oral hygiene practices can be used. Dyes effectively used at a dentist's office include the use of water-insoluble colorants in non-toxic carriers which can only be removed mechanically from the mouth, and fluorescent dyes which require application of a light source to be observable.

A disclosant dye must meet certain criteria in order to be useful as a plaque disclosing agent, particularly for home use. Firstly, the dye must be capable of adequately penetrating the plaque deposit, and stain said plaque so as to be readily visible to the user, without producing an excessively prolonged staining effect. This staining efficacy must be selective so as to identify the areas of plaque-formation on all tooth surfaces and not unduly stain gingival or other oral tissues. This selective staining efficacy must be coupled with easy removability from the mouth by simply washing or rinsing after use, i.e. it should be water-soluble. In addition, the taste must be pleasant and acceptable to the user, and the color must be pleasing. It must be harmless and non-toxic. Further, it should be visible under normal light conditions, not dependent on fluorescence excitation sources.

It has been known to those skilled in the art that FD&C Red No. 40, also known as Allura Red, a water-soluble dye, has the desired attributes of an ideal plaque disclosing agent. This non-toxic dye provides a strong color intensity to the disclosed plaque, which is observable by the naked eye at visible light wavelengths, providing a sharp contrast between the disclosed plaque and surrounding soft and hard oral tissues; is water-soluble so that excess may be substantially rinsed out of the mouth and off of sink surfaces; and is more palatable to the taste than other commonly used disclosing dyes.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated. The lights 202-206 can be an ultra-violet light to highlight the dental plaque so the user can focus on problem areas.

A UV laser can be used in place of the LEDs. To generate a UV laser, first, an infrared laser is frequency doubled to a green light laser, and then a green light laser is frequency doubled to an UV laser. In one embodiment, A UV light generator for receiving a baseband light beam from a baseband light source includes a first lens unit, a second lens unit, a first frequency doubling crystal and a second frequency doubling crystal. The baseband light beam from the baseband light source passes through the first lens unit. The first lens unit and the second lens unit control a minimum of baseband light spot position and a minimum of second harmonic light spot position. The first frequency doubling crystal is disposed between the first lens unit and the second lens unit, and located on the minimum of baseband light spot position, wherein the baseband light beam passes through the first frequency doubling crystal to become a second harmonic light beam. The second frequency doubling crystal is disposed between the first lens unit and the second lens unit, and located on the minimum of second harmonic light spot position.

Utilizing the UV light generator of this embodiment, the baseband light beam and the second harmonic light beam are repeatedly reflected (resonate) between the first lens unit and the second lens unit to be sufficiently absorbed thereby and to improve energy utility efficiency. Thus, optical energy utility rate is increased. Additionally, the first frequency doubling crystal is located on the minimum of baseband light spot position and the second frequency doubling crystal is located on the minimum of second harmonic light spot position, to increase UV light conversion efficiency.

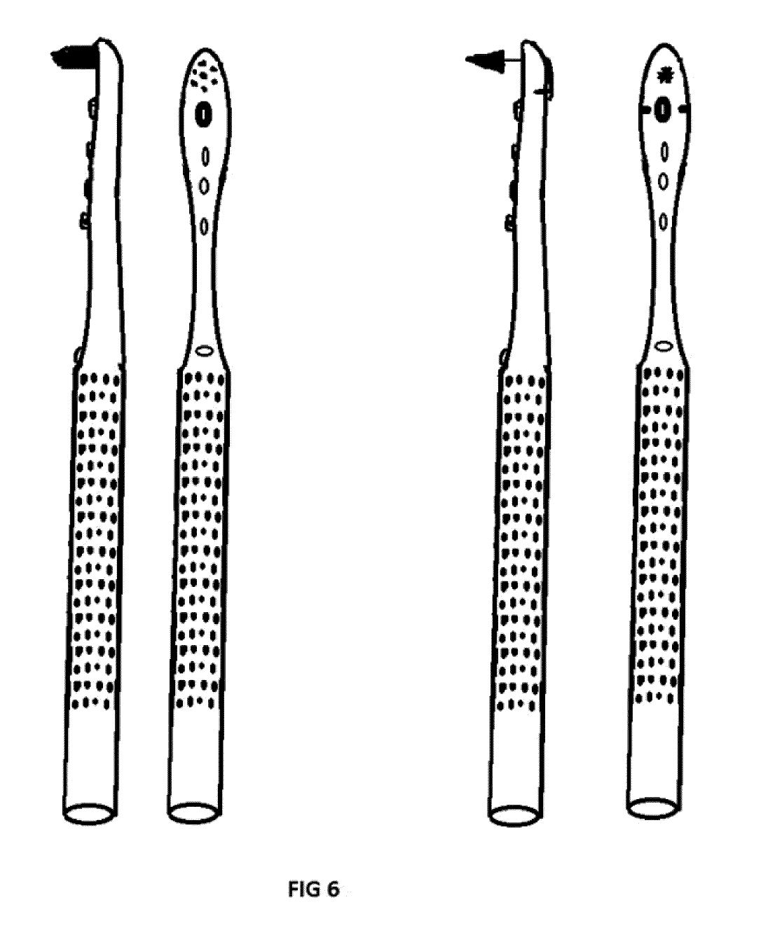

FIG. 6 shows embodiments to help clean specific dental locations. In FIG. 6, in place of the brush, a cleaning head is present. The cleaning head has a small profile that allows it to go through the interproximal openings between teeth to allow better cleaning In one embodiment, the cleaning head has six projections to reach hard to access locations between the teeth. In another embodiment, the cleaning head has one brush wire that is expandable to allow the wire to floss between two teeth. In this embodiment, one or more lights can be positioned on the neck and/or the top of the handle. The light can be positioned around the top part of the toothbrush handle and/or along the neck of the toothbrush with the purpose of illuminating the cleaning head and giving the user a better vision of the area where he/she is flossing or cleaning. In one embodiment, the head can be secured by a clip to retain the replaceable cleaning tip on the head.

The present invention has been described in considerable detail in order to comply with the patent laws by providing full public disclosure of at least one of its forms. However, such detailed description is not intended in any way to limit the broad features or principles of the present invention, or the scope of the patent to be granted. Therefore, the invention is to be limited only by the scope of the appended claims.

What is claimed is:

1. A manual or electrical toothbrush handle for cleaning teeth and gum pockets, the toothbrush comprising:
a handle completely encased with gripping elements for full-gripping.

2. The handle of claim 1, wherein the full-gripping handle is shaped for adjusting angle of the toothbrush bristles, controlling the direction of the toothbrush and allowing different types of grips.

3. The handle of claim 2, wherein the full-gripping handle is full-gripping handle is coned-shaped, cylindrical-shaped, octagon-shaped, oval-shaped or polygon-shaped.

4. The handle of claim 1, wherein the entire surface of the handle comprises gripping elements or flat yet tacky materials wherever the fingers touch.

5. A manual or electrical toothbrush comprising:
a neck portion;
a toothbrush head extending from one end of the neck portion;
a grip handle extending from the other end of the neck portion, wherein the grip handle includes an array of gripping elements covering the entire surface of the grip handle; and one or more lights positioned on the neck portion or near the top of the grip handle.

6. The toothbrush of claim 5, wherein the full-gripping handle is coned-shaped, cylindrical-shaped, octagon-shaped, oval-shaped or polygon-shaped.

7. The toothbrush of claim 5, wherein the array of gripping elements includes bumps or studs on the entire surface of the grip handle.

8. The toothbrush of claim 5, wherein the array of gripping elements includes concave indentations on the entire surface of the grip handle.

9. The toothbrush of claim 5, wherein the array of gripping elements includes suction cups on the entire surface of the grip handle.

10. The toothbrush of claim 5, wherein the array of gripping elements includes continuous line extrusions or continuous concave depressions on the entire surface of the grip handle.

11. The toothbrush of claim 5, wherein the gripping surface can be flat but tacky for finger grasp.

12. The toothbrush of claim 5, comprising a vibrator in the grip handle.

13. The toothbrush of claim 5, comprising brush bristles on the toothbrush head with varying height to allow the head to brush a hard-to-reach dental region.

14. The toothbrush of claim 5, wherein the vibrator comprises a motor that is improperly balanced for vibration.

15. The handle of claim 1, wherein the handle includes an array of gripping elements or flat yet tacky material covering the entire surface of the grip handle; and brushing a user's teeth; and a light near the neck portion or near a top of the grip handle to view the teeth and bristles.

16. The handle of claim 1, wherein the handle receives a brushing motion by holding the toothbrush as though the toothbrush is a pen, a pencil or a chop-stick during the entire tooth brushing procedure;
maintaining a holding elbow in down position next to a user's side;
maintaining the wrist straight and letting fingertips and/forearm do the brushing;
rolling the grip handle in the fingertips to adjust angles of the toothbrush bristles against the teeth to form the 45 degree angles when brushing teeth.

17. The handle of claim 1, wherein the grip handle is cylindrical-shaped, octagon-shaped, coned-shaped, polygon-shape or oval-shaped.

18. The handle of claim 1, comprising suction indentations, cups, bumps, studs, continuous line extrusions or continuous concave depressions covering the entire surface of the grip handle.

19. The handle of claim 1, wherein the full-gripping handle is held with a chopstick finger grip or a pencil finger grip or dentists/dental hygienists dental cleaning instruments′grip during the entire tooth brushing procedure.

20. The handle of claim 1, comprising a vibrator in the grip handle using a motor that is improperly balanced for vibration.
